(19) United States
(12) Patent Application Publication
(10) Pub. No.: US 2026/0286996 A1
(43) Pub. Date: Sep. 24, 2026

(54) BLIND FASTENING DEVICE WHICH CAN BE RE-TIGHTENED AFTER INSTALLATION, AND METHOD FOR INSTALLATION OF A BLIND FASTENING DEVICE OF THIS TYPE

(71) Applicant: Airbus Operations SAS, TOULOUSE (FR)

(72) Inventor: Alexandre CARON, TOULOUSE (FR)

(21) Appl. No.: 19/559,112

(22) Filed: Mar. 6, 2026

(30) Foreign Application Priority Data
Mar. 24, 2025 (FR) FR2503011

(51) Int. Cl. F16B 5/02; F16B 31/02

(52) U.S. Cl. CPC F16B 5/0258; F16B 31/021

(57) ABSTRACT

A blind fastening device which can be re-tightened after installation, and method for installation of a blind fastening device of this type. The blind fastening device has an actuation rod with a deformation bush, and a sleeve with a deformation bush and a deformable portion which is configured to be deformed radially when the deformation bushes cooperate. The actuation rod has a first drive nut followed by a first rupture groove configured to rupture when a tightening torque applied to the first drive nut exceeds a first predetermined torque, and a second drive nut followed by a second rupture groove configured to rupture when a re-tightening torque applied to the second drive nut exceeds a second predetermined torque greater than the first predetermined torque.

### CROSS-REFERENCES TO RELATED APPLICATIONS

This application claims the benefit of French Patent Application Number FR 2503011, filed on Mar. 24, 2025, the entire disclosure of which is incorporated herein by way of reference.

### FIELD OF THE INVENTION

The present application relates to a blind fastening device which is designed to permit re-tightening of the fastening after installation, as well as to a method for installation of a blind fastening device of this type.

### BACKGROUND OF THE INVENTION

Blind fastening devices are used at present, in particular in the domain of aeronautics, in order to assemble elements to one another, when the operator in charge of the assembly of said elements has access only from a single side of the assembly. These blind fastening devices will tend to be used more extensively in the future, since they are one of the key elements of automation of an assembly line.

An interface seal is often applied between the elements to be assembled, such that the assembly is sealed against fluids (impermeability to water, as well as to the air for the pressurization of the aircraft cabin for example), in order to avoid potential leakages, such as fuel leakages, and such as to prevent the corrosion of one or the other of the elements which compose the assembly when different materials compose the assembled elements (for example when one of the elements is made from carbon-fiber reinforced polymer (CFPR)).

The interface seal is generally applied before the steps of final assembly making it possible to assemble a first element to a second element.

After the application of the interface seal, it is necessary to maintain a predetermined pressure on the assembly during the creep and drying time of the interface seal, in order to ensure total sealing of the assembled structure.

In order to guarantee correct pressing of the interface seal, it is necessary to use temporary fastening devices. This method consists of the installation of temporary fastening devices in order to assemble the elements, of the application of the necessary pressure on the assembly, so as to ensure pre-tightening of the assembly and to guarantee homogeneousness of the thickness of the seal at the interface between the first and second assembled elements, and of replacement of the temporary fastening devices by definitive fastening devices, with the definitive fastening devices being correctly tightened so as to ensure correct contact and a sufficient tightening force between the elements to be assembled. This method is, however, costly in terms of time and materials, since it is necessary to install and remove numerous temporary fastening devices.

In order to dispense with temporary fastening devices, it would be necessary to use definitive fastening devices which can be re-tightened after the pressing and drying of the seal. A first tightening of the definitive fastening devices would make it possible to ensure pressing of the interface seal, and a second tightening (i.e., re-tightening) of the definitive fastening devices would make it possible to ensure correct preloading of the definitive fastening devices after the pressing of the seal, and to ensure close contact between the elements to be assembled. However, this type of blind fastening device has not existed hitherto, since the existing blind fastening devices are not designed to be re-tightened.

There is therefore a need for a blind fastening device in order to assemble elements to one another, such as to form an assembly which can be tightened for a first time, and re-tightened subsequently.

### SUMMARY OF THE INVENTION

An objective of the present invention is to propose a solution which permits re-tightening of a blind fastening device after its installation.

For this purpose, in at least one aspect the invention provides a blind fastening device for fastening of an assembly of a first element to a second element, an interface seal being positioned between said first and second elements, said first and second elements each comprising an orifice with the first inner diameter, said blind fastening device comprising:
an actuation rod with first and second ends, and comprising a first drive nut at its first end, a first rupture groove between the first drive nut and its second end, a threaded portion between the first rupture groove and its second end, and a deformation bush at its second end;
a sleeve which can be inserted in the orifices of said first and second elements, and having a first outer diameter which is substantially equal to the first inner diameter, the sleeve being able to be threaded onto the actuation rod, and having first and second ends, and comprising a tapped portion between its first and second ends, a deformation bush at its second end, and a deformable portion between its first and second ends which is configured to be deformed radially until the sleeve has a second outer diameter larger than the first outer diameter, when the deformation bush of the actuation rod cooperates with the deformation bush of the sleeve,
wherein said first rupture groove is configured to rupture when a tightening torque applied to the first drive nut giving rise to the cooperation of the threaded portion of the actuation rod with the tapped portion of the sleeve exceeds a first predetermined torque.

According to at least one of the invention, the actuation rod comprises a second drive nut followed by a second rupture groove between the first rupture groove and the threaded portion, said second rupture groove being configured to rupture when a re-tightening torque applied to the second drive nut exceeds a second predetermined torque greater than said first predetermined torque.

Advantageously, the presence of the second drive nut followed by the second rupture groove makes it possible to introduce a re-tightening function of the blind fastening device, and more specifically of the actuation rod in the sleeve, after pressing of the interface seal between the first and second elements of the assembly. In addition, since the second rupture groove is calibrated for a predetermined tightening torque, correct re-tightening of the blind fastening devices is guaranteed, and any under-tightening or over-tightening of the blind fastening device is thus avoided.

According to another characteristic, the deformation bush of the actuation rod is in the form of a thread, and the deformation bush of the sleeve is in the form of tapping.

According to another characteristic, the deformation bush of the actuation rod is in the form of a radial protuberance, and the deformation bush of the sleeve is in the form of a radial expansion.

According to another characteristic, the deformation bush of the actuation rod is in the form of a radial protuberance, and the deformation bush of the sleeve is in the form of a support surface, against which the deformation bush of the actuation rod is supported.

In at least one aspect, the present invention also provides a method for installation of a blind fastening device, for fastening of the assembly of the first element to the second element, comprising:
a step of insertion of the blind fastening device in the orifices of the first and second elements;
a step of cooperation of the deformation bush of the actuation rod with the deformation bush of the sleeve, such as to deform the deformable portion of the sleeve radially until the sleeve has a second outer diameter larger than the first outer diameter, with the cooperation of the deformation bush of the actuation rod with the deformation bush of the sleeve making it possible to arrange the threaded portion of the actuation rod facing the tapped portion of the sleeve;
a step of screwing of the threaded portion of the actuation rod into the tapped portion of the sleeve, via the first drive nut, until the first rupture groove ruptures.

According to at least one aspect, the method also comprises:
a step of re-tightening of the threaded portion of the actuation rod in the tapped portion of the sleeve, via the second drive nut, until the second rupture groove ruptures.

Advantageously, the installation of a fastening device of this type makes it possible to avoid the use of temporary blind fastening devices, and thus permits direct use of definitive blind fastening devices, which are re-tightened after installation and pressing of the interface seal which is arranged between the first and second elements of the assembly.

According to another characteristic, the deformation bush of the actuation rod is in the form of a thread, and the deformation bush of the sleeve is in the form of tapping, and the step of cooperation of the deformation bush of the actuation rod with the deformation bush of the sleeve comprises a sub-step of screwing of the deformation bush of the actuation rod into the deformation bush of the sleeve, such that the thread of the deformation bush of the actuation rod cooperates with the tapping of the deformation bush of the sleeve.

According to another characteristic, the deformation bush of the actuation rod is in the form of a radial protuberance, and the deformation bush of the sleeve is in the form of a radial expansion, and the step of cooperation of the deformation bush of the actuation rod with the deformation bush of the sleeve comprises a sub-step of traction of the deformation bush of the actuation rod in the deformation bush of the sleeve, such that the radial protuberance of the deformation bush of the actuation rod cooperates with the radial expansion of the deformation bush of the sleeve.

According to another characteristic, the deformation bush of the actuation rod is in the form of a radial protuberance, and the deformation bush of the sleeve is in the form of a support surface, and the step of cooperation of the deformation bush of the actuation rod with the deformation bush of the sleeve comprises a sub-step of traction of the deformation bush of the actuation rod in the deformation bush of the sleeve, such that the radial protuberance of the deformation bush of the actuation rod cooperates with the support surface of the deformation bush of the sleeve.

The subject of the invention is also an assembly of a first element and a second element comprising a blind fastening device according to the invention, said blind fastening device being designed to fasten said first element on said second element.

The subject of the invention is also an aircraft comprising at least one assembly according to the invention.

### BRIEF DESCRIPTION OF THE DRAWINGS

Other characteristics and advantages will become apparent from the following description of the invention, which description is provided purely by way of example, with reference to the appended drawings, in which:

FIG. 1 is a view in cross-section of a blind fastening device not assembled, and of first and second elements to be assembled, which illustrates a step of a first embodiment of the invention;

FIG. 2 is a view in cross-section of a blind fastening device assembled, and of first and second elements to be assembled, which illustrates another step of a first embodiment of the invention;

FIG. 3 is a view in cross-section of a blind fastening device and an assembly of first and second elements, which illustrates another step of a first embodiment of the invention;

FIG. 4 is a view in cross-section of a blind fastening device fastened in an assembly of first and second elements, which illustrates another step of a first embodiment of the invention;

FIG. 5 is a view in cross-section of a blind fastening device re-tightened in an assembly of first and second elements, which illustrates another step of a first embodiment of the invention;

FIG. 6 is a flowchart of a method for installation of a blind fastening device for fastening of an assembly of a first element with a second element, which illustrates an embodiment of the invention;

FIG. 7 is a view in cross-section of a blind fastening device not assembled, and of first and second elements to be assembled, which illustrates a step of a second embodiment of the invention;

FIG. 8 is a view in cross-section of a blind fastening device assembled, and of first and second elements to be assembled, which illustrates another step of a second embodiment of the invention;

FIG. 9 is a view in cross-section of a blind fastening device and of an assembly of first and second elements, which illustrates another step of a second embodiment of the invention;

FIG. 10 is a view in cross-section of a blind fastening device re-tightened in an assembly of first and second elements, which illustrates another step of a second embodiment of the invention;

FIG. 11 is a view in cross-section of a blind fastening device not assembled, and of first and second elements to be assembled, which illustrates a step of a third embodiment of the invention;

FIG. 12 is a view in cross-section of a blind fastening device assembled, and of first and second elements to be assembled, which illustrates another step of a third embodiment of the invention;

FIG. 13 is a view in cross-section of a blind fastening device, and of an assembly of first and second elements, which illustrates another step of a third embodiment of the invention; and

FIG. 14 is a view a perspective of an aircraft comprising an assembly of first and second elements, which illustrates an embodiment of the invention.

### DETAILED DESCRIPTION OF THE PREFERRED EMBODIMENTS

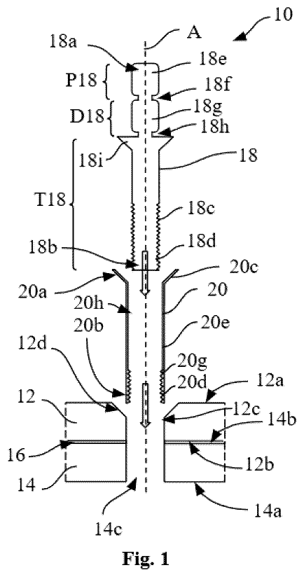

FIGS. 1 to 5 represent the installation of a first type of blind fastening for fastening together the elements of an aircraft, i.e., a device for blind fastening by tightening, known as a blind fastening device “to be tightened”.

As illustrated in FIGS. 1 to 5, the blind fastening device 10 is used to fasten two elements 12, 14 to one another. The blind fastening device 10 is used in this case to assemble a first element 12, situated on the side of the assembly which is accessible for an operator, and a second element 14, situated on the side of the assembly which is inaccessible when the elements 12, 14 are fastened to one another.

The first element 12 thus comprises a first face 12a which is arranged on the accessible side of the assembly, and a second face 12b which is arranged facing the second element 14. The second element comprises a first face 14a which is arranged on the inaccessible side of the assembly, and a second face 14b which is arranged facing the first element 12. An interface seal 16 is present between the first and second elements 12, 14, and in particular between the two faces 12b, 14b of the elements 12, 14.

Each element 12, 14 comprises a through-orifice 12c, 14c, in which the fastening device is designed to be inserted. These orifices 12c, 14c are coaxial along the longitudinal axis A, as represented in FIG. 1. In this case, the orifices 12c, 14c have a substantially cylindrical form with a circular base. The orifice 12c has a widening 12d at the first face 12a of the element 12, against which the blind securing device 10 will be supported.

The blind securing device 10 comprises an actuation rod 18, in this case a tightening rod, as well as a sleeve 20 which receives the actuation rod 18, and is designed to be placed in the orifices 12c, 14c of the elements 12, 14 to be fastened to one another.

The actuation rod 18 comprises a body extending longitudinally along the longitudinal axis A and having a first end 18a arranged on the accessible side of the assembly, and a second end 18b opposite the first end 18a, and arranged on the side of the assembly which is inaccessible when the actuation rod 18 is inserted in the sleeve 20, which is itself placed in the orifices 12c, 14c of the elements 12, 14 to be assembled. The actuation rod 18 comprises a threaded portion 18c between its first and second ends 18a, 18b, as well as a deformation bush 18d at its second end 18b. In this case, the deformation brush 18d is in the form of a thread. The actuation rod also comprises a first drive nut 18e at its first end 18a, which is separated from the body of the actuation rod 18 by a first rupture groove 18f. The first rupture groove 18f is thus spaced from the first end 18a of the actuation rod 18, and makes it possible to define a first portion P18 of the actuation rod 18, also comprising at the first end 18a the first drive nut 18e. The actuation rod 18 also comprises a second drive nut 18g between the first rupture groove 18f and the body of the actuation rod 18, spaced from the second end 18b of the actuation rod 18. This second drive nut 18g is separated from the body of the actuation rod 18 by a second rupture groove 18h. The second drive nut 18g is thus arranged between the first and second rupture grooves 18f, 18h. A second portion D18 of the actuation rod 18 is thus defined, and comprises the second drive nut 18g and the second rupture groove 18h. Preferably, the second drive nut 18g is identical to the first drive nut 18e, so that an operator can use the same tightening tool for the first and second drive nuts 18e, 18g. It will be appreciated that these first and second drive nuts 18e, 18g can be different. The actuation rod 18 comprises a cylindrical flange 18i arranged between the second rupture groove 18h and the body of the actuation rod 18, spaced from the second end 18b of the actuation rod 18. The flange 18i forms a radial protuberance (i.e., in a direction which is radial relative to the longitudinal axis A) from the body of the actuation rod 18. The flange 18i has a form which is substantially (+/−10%) complementary to the form of the widening 12d of the orifice 12c of the element 12. A third portion T18 of the actuation rod 18 is thus defined between the flange 18i and the second end 18b of the actuation rod 18. Between its first and second ends 18a, 18b, the actuation rod 18 thus comprises the first drive nut 18e, then the first rupture groove 18f, the second drive nut 18g, then the second rupture groove 18h, the flange 18i, the threaded portion 18c, then the deformation bush 18d. The first drive nut 18e, the first rupture groove 18f, the second drive nut 18g, the second rupture groove 18h and the flange 18i are arranged in continuity with one another. With the exception of the flange 18i and the first and second rupture grooves 18f, 18h, the actuation rod 18 has a substantially constant diameter, equal to the inner diameter of the sleeve 20. The actuation rod 18 is fitted with little play in the sleeve 20, i.e. with sufficient play to permit securing of the actuation rod 18 into the sleeve 20.

The sleeve 20 comprises a hollow cylindrical body extending longitudinally along the longitudinal axis A and defining a through-orifice 20h. The sleeve 20 has a first end 20a arranged on the accessible side of the assembly, and a second end 20b opposite the first end 20a, and arranged on the side of the assembly which is inaccessible when the sleeve 20 is placed in the orifices 12c, 14c of the elements 12, 14 to be assembled. The sleeve 20 comprises a flange 20c which is substantially annular at its first end 20a. The flange 20c has an outer form which is substantially complementary to the form of the widening 12d of the orifice 12c of the element 12, and an inner form which is substantially complementary to the form of the flange 18i of the actuation rod 18. The sleeve 20 also comprises a deformation bush 20d at its second end 20b, which in this case is in the form of tapping. The sleeve 20 comprises a deformable portion 20e, arranged between the deformation bush 20d and the flange 20c, spaced from the first and second ends 20a, 20b of the sleeve 20. The sleeve 20 also comprises a tapped portion 20g arranged between the deformation bush 20d and the deformable portion 20e. Between its first and second ends 20a, 20b, and in this order, the sleeve 20 thus comprises the flange 20c, the deformable portion 20e, the tapped portion 20g and the deformation bush 20d. Although not represented in the figures, between its first and second ends, the sleeve could comprise, in this order, the flange, the threaded portion, the deformable portion and the deformation bush.

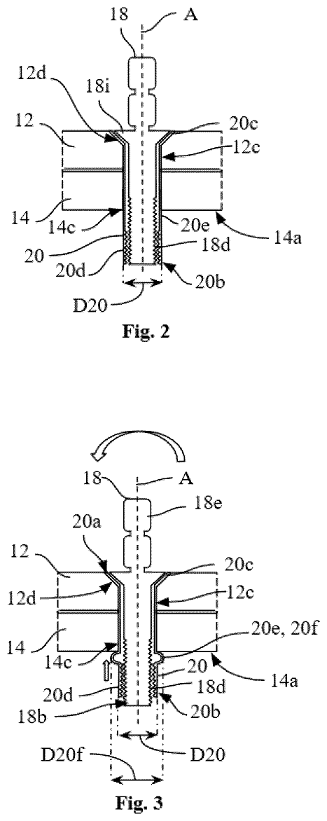

As represented in FIG. 2, after installation of the sleeve 20 in the orifices 12c, 14c of the elements 12, 14, the flange 20c of the sleeve 20 is supported against the widening 12d of the orifice 12c of the first element 12 of the assembly. The second end 20b of the sleeve 20, and in particular the deformable portion 20e and the deformation bush 20d of the sleeve 20, extend beyond the orifice 14c of the second element 14 of the assembly, i.e., they extend beyond the first face 14a of the second element 14. The outer diameter D20 of the sleeve 20 is substantially equal to the inner diameter of the orifices 12c, 14c of the elements 12, 14. The sleeve 20 is thus fitted without play in the orifices 12c, 14c of the elements 12, 14. In particular, the outer diameter of the flange 20c of the sleeve 20 is substantially equal to the inner diameter of the widening 12d of the orifice 12c of the first element 12. Also, the outer diameter of the body of the sleeve 20 is substantially equal to the inner diameter of the orifices 12c, 14c of the first and second elements 12, 14.

The flange 18i of the actuation rod 18 is supported against the inner surface of the annular flange 20c of the sleeve 20. The second end 18b of the actuation rod 18, and in particular the deformation bush 18d of the actuation rod 18, extends beyond the orifice 14c of the second element 14 of the assembly, i.e., it extends beyond the first face 14a of the second element 14. The deformation bush 18d of the actuation rod 18 is arranged facing the deformation bush 20d of the sleeve 20.

After insertion of the blind fastening device 10, the actuation rod 18, the sleeve 20 and the orifices 12c, 14c of the first and second elements 12, 14 are coaxial along the longitudinal axis A. As represented in FIG. 2, once the blind fastening device 10 is installed in the orifices 12c, 14c of the first and second elements 12, 14, the first and second portions P18, D18 of the actuation rod 18 project in relation to the first face 12a of the first element 12, and the deformable portion 20e, the deformation bush 20d of the sleeve 20 as well as the deformation bush 18d of the actuation rod 18, project in relation to the first face 14a of the second element 14. Thus, the first and second portions P18, D18 of the actuation rod 18 are situated on the accessible side of the assembly, whereas the deformation bushes 18d, 20d are situated on the inaccessible side of the assembly.

In order to fasten the first and second elements 12, 14 together, and as represented in FIG. 3, the actuation rod 18 is rotated in relation to the sleeve 20. More specifically, the actuation rod 18 is rotated via the first drive nut 18e, by means of a tightening tool (not represented in the figures) which is manipulated by an operator, in relation to the sleeve 20. The thread of the deformation bush 18d cooperates with the tapping of the deformation bush 20d, which has the consequence of driving the second end of the sleeve 20 in the direction of the assembly, along the longitudinal axis A. The deformation bush 20d of the sleeve 20 is controlled in its displacement by the screwing of the actuation rod 18, and more specifically by the screwing of the deformation bush 18d of the actuation rod 18. The second end 20b of the sleeve 20 is thus at a shorter distance from the first face 14a of the second element 14 after deformation of the sleeve 20, whereas the second end 18b of the actuation rod 18 remains at the same distance from the first face 14a of the second element 14, before and after deformation of the sleeve 20. Since the first end 20a of the sleeve 20 is maintained supported against the widening 12d of the orifice 12c of the first element 12, a compression force is exerted on the sleeve 20, between the flange 20c at the first end 20a of the sleeve 20, and the deformation bush 20d at the second end 20b of the sleeve 20, such that the deformable portion 20e of the sleeve 20 is deformed under the force applied by the screwing of the actuation rod 18 in the sleeve 20, and forms a deformation bulb 20f. The deformation bulb 20f forms a radial expansion of the sleeve 20. The deformable portion 20e of the sleeve 20 is controlled in its expansion by the screwing of the actuation rod 18 into the sleeve 20, and more specifically by the screwing of the deformation bush 18d of the actuation rod 18 into the deformation bush 20d of the sleeve 20. The deformable portion 20e of the sleeve is designed to be the portion of the sleeve 20 which is the first to be deformed in the case of a compression force greater than a predetermined threshold applied longitudinally along the longitudinal axis A on the sleeve 20. The deformable portion 20e of the sleeve 20 can, in a non-limiting manner, have a smaller thickness than the remainder of the sleeve 20, such as to make this portion of the sleeve primo-deformable further to a compression force (i.e. it is deformed as a priority). The deformable portion 20e thus deformed is supported against the first face 14a of the second element 14 of the assembly. The deformation bulb 20f has an outer diameter D20f which is larger than the outer diameter D20 of the non-deformed sleeve 20. This outer diameter D20f is larger than the diameter of the orifice 14c of the second element 14, such that the deformation bulb 20f is supported against the first face 14a of the second element 14. The elements 12, 14 of the assembly are maintained against one another between the flange 20c and the deformation bulb 20f of the sleeve 20.

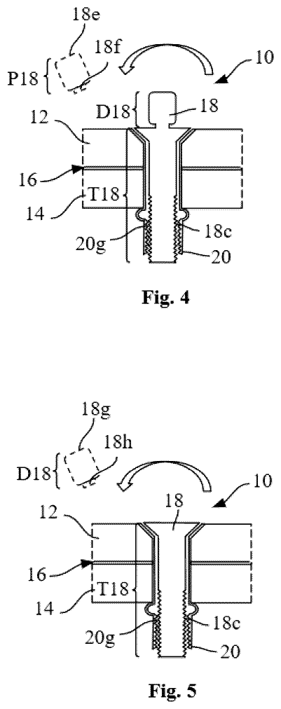

In order to ensure correct tightening of the actuation rod 18 in the sleeve 20, the first rupture groove 18f is calibrated so as to rupture as soon as a first predetermined tightening torque is applied to the first drive nut 18e. This first determined tightening torque corresponds to the tightening which is necessary and sufficient to permit maintenance of a predetermined pressure on the interface seal 16 of the assembly. Thus, when the tightening torque applied to the actuation rod 18 (to the first drive nut 18e) exceeds the first predetermined tightening torque, this means that the blind fastening device 10 is correctly installed for ensuring the pressing of the interface seal 16 between the first and second elements 12, 14. As represented in FIG. 4, the actuation rod 18, and in particular the first drive nut 18e, is rotated by means of a tightening tool (not represented in the figures), manipulated by an operator, relative to the sleeve 20, until the rupture groove 18f ruptures. During this rotation of the actuation rod 18, the threaded portion 18c of the actuation rod 18 cooperates with the tapped portion 20g of the sleeve 20. In fact, for the formation of the deformation bulb 20f, and thus of the deformation of the deformable portion 20e, it is the deformation bush 18d of the actuation rod 18 which cooperates with the deformation bush 20d of the sleeve 20; however, once the deformation bulb 20f has been formed, it is the cooperation of the threaded portion 18c of the actuation rod 18 with the tapped portion 20g of the sleeve 20 which makes it possible to define the tightening torque to be applied to the first drive nut 18e before rupture of the first rupture groove 18f. The first portion P18 of the actuation rod 18, i.e., the first drive nut 18e and the first rupture groove 18f, is thus withdrawn from the blind fastening device 10, and the actuation rod 18 thus retains only its second portion D18 and its third portion T18.

In order to ensure correct re-tightening of the actuation rod 18 in the sleeve 20, the second rupture groove 18h is calibrated so as to rupture as soon as a second predetermined tightening torque is applied to the second drive nut 18g. This second predetermined tightening torque corresponds to the tightening which is necessary and sufficient to permit correct preloading of the blind fastening device 10. Thus, when the tightening torque applied to the actuation rod 18, more specifically to the second drive nut 18g, exceeds the second predetermined tightening torque, this means that the blind fastening device 10 is correctly and definitively installed in order to ensure the preloading of the blind fastening device 10. As represented in FIG. 5, the actuation rod 18, and in particular the second drive nut 18g, is rotated by means of a tightening tool (not represented in the figures) manipulated by an operator, in relation to the sleeve 20, until the rupture groove 18h ruptures. During this rotation of the actuation rod 18 for the purpose of re-tightening of the blind fastening device 10, the threaded portion 18c of the actuation rod 18 cooperates with the tapped portion 20g of the sleeve 20. The second portion D18 of the actuation rod 18, i.e., the second drive nut 18g and the second rupture groove 18h, is thus withdrawn from the blind fastening device 10, and the actuation rod 18 retains only its third portion T18.

The first predetermined tightening torque is lower than the second predetermined tightening torque, such that the first rupture groove 18f ruptures before the second rupture groove 18h. The tightening torque to be applied in order to ensure the pressing of the seal 16 is thus lower than the tightening torque to be applied in order to ensure the preloading of the blind fastening device 10.

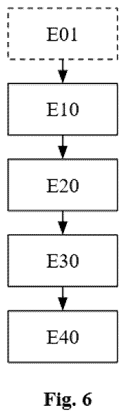

The method for installation of a blind fastening device 10 definitively is illustrated in FIG. 6.

Firstly, this method comprises a step E01 of application of an interface seal 16 between the first and second elements 12, 14 to be assembled.

The following steps of the method permit correct pressing of the interface seal 16 between the first and second elements 12, 14 to be assembled, such that the interface seal 16 has a constant thickness between said elements 12, 14.

The method comprises a step E10 of insertion of the blind fastening device 10 in the coaxial orifices 12c, 14c of the first and second elements 12, 14 which are designed to be assembled. More specifically, the sleeve 20, in which the actuation rod 18 has previously been inserted, is inserted in the orifices 12c, 14c of the first and second elements 12, 14. In general, the actuation rod 18 is inserted in the sleeve 20 before the installation of the blind fastening device 10. It will be appreciated that the sleeve 20 could firstly be inserted in the orifices 12c, 14c of the first and second elements 12, 14, without the actuation rod 18 being inserted in the sleeve 20, then the actuation rod 18 could be inserted in its turn into the orifice 20h of the sleeve 20.

The sleeve 20 is inserted in the orifice 12c of the first element 12 to be assembled, starting from the first face 12a of the element 12, via its second end 20b. The sleeve 20 is then inserted into the orifice 14c of the second element 14, which is coaxial with the orifice 12c of the first element 12. The second end 20b of the sleeve 20 opens beyond the first face 14a of the second element 14. The flange 20c of the sleeve 20, arranged at the first end 20a of the sleeve 20, is supported against the widening 12d of the orifice 12c of the first element 12. The sleeve 20 is adjusted in the orifices 12c, 14c of the first and second elements 12, 14, i.e., the sleeve 20 is fitted without play in said orifices 12c, 14c.

With the blind fastening device 10 in position in the orifices 12c, 14c of the elements 12, 14, the second end 18b of the actuation rod 18 is flush with the second end 20b of the sleeve 20. The flange 18i of the actuation rod 18 is supported against the flange 20c of the sleeve 20. The deformation bush 18d of the actuation rod 18 is positioned facing the deformation bush 20d of the sleeve 20. The actuation rod 18 is fitted with slight play in the orifice 20h of the sleeve 20, such as to permit screwing of the actuation rod 18 into the sleeve 20.

The method then comprises a step E20 of deformation of the deformable portion 20e of the sleeve 20, derived from the cooperation of the deformation bush 18d of the actuation rod 18 with the deformation bush 20d of the sleeve 20. This step E20 of deformation makes it possible to fasten the blind fastening device 10 on the first and second elements 12, 14.

In this case, the step E20 comprises a sub-step of screwing of the threaded deformation bush 18d of the actuation rod 18 into the tapped deformation bush 20d of the sleeve 20, which has the consequence of driving the second end 20b of the sleeve 20 in the direction of its first end 20a. With the sleeve 20 maintained by means of its flange 20c against the first face 12a of the first element 12, this gives rise to compression of the sleeve 20, and in particular to compression of the deformable portion 20e of the sleeve 20 against the first face 14a of the second element 14. Since the deformable portion 20e is designed to be deformed after application of a compression force greater than a predetermined threshold, when this predetermined threshold is exceeded further to the screwing of the actuation rod 18 into the sleeve 20, this gives rise to deformation of the deformable portion 20e, and to the creation of the deformed portion 20f of the sleeve 20. The screwing of the threaded deformation bush 18d of the actuation rod 18 into the tapped deformation bush 20d of the sleeve 20 makes it possible to arrange the threaded portion 18c of the actuation rod 1 facing the tapped portion 20g of the sleeve 20.

The method then comprises a step E30 of screwing of the actuation rod 18 into the sleeve 20, and more specifically screwing of the threaded portion 18c of the actuation rod 18 into the tapped portion 20g of the sleeve 20, via the first drive nut 18e, until the first rupture groove 18f ruptures. More specifically, by means of a tightening tool (not represented in the figures), an operator will screw the first drive nut 18e into the sleeve 20, i.e., apply a tightening torque on the first drive nut 18e in relation to the sleeve 20, until the first rupture groove 18f shears. The rupture of the first rupture groove 18f means that the blind fastening device 10 is tightened on the assembly of the first and second elements 12, 14 sufficiently to maintain an adequate pressure on the interface seal 16.

The following step of the method is carried out after pressing, creeping and drying of the interface seal 16, and permits correct preloading of the blind fastening device 10.

The method then comprises a step E40 of re-tightening of the actuation rod 18 in the sleeve 20, and more specifically screwing of the threaded portion 18c of the actuation rod 18 into the tapped portion 20g of the sleeve 20, via the second drive nut 18g, until the second rupture groove 18h ruptures. More specifically, by means of a tightening tool (not represented in the figures), an operator will screw the second drive nut 18g into the sleeve 20, i.e., apply a tightening torque on the second drive nut 18g in relation to the sleeve 20, until the second rupture groove 18h shears. The rupture of the second rupture groove 18h means that the blind fastening device 10 is tightened on the assembly of the first and second elements 12, 14 sufficiently to ensure preloading of the blind fastening device 10.

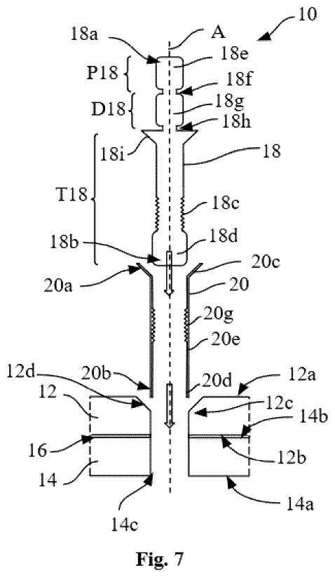

FIGS. 7 to 10 represent the installation of a second type of blind fastening device, in order to fasten together the elements of a structure of an aircraft, i.e., a device for blind fastening by traction and tightening, known as a blind fastening device “to be drawn”. Only the differences between the first and second types of blind fastening are described hereinafter for reasons of clarity. The characteristics which are not described of the first type of blind fastening therefore apply also to this second type of blind fastening.

The blind fastening device 10 comprises an actuation rod 18, in this case a traction rod, which is designed to be inserted in the sleeve 20.

The actuation rod 18 comprises a deformation bush 18d at its second end 18b. In this case, the deformation bush 18d is in the form of a protuberance which is radial (in relation to the longitudinal axis A). With the exception of the flange 18i, the first and second rupture grooves 18f, 18h, and the deformation bush 18d, the actuation rod 18 has a substantially constant diameter, equal to the inner diameter of the sleeve 20. Thus, the diameter of the deformation bush 18d is larger than the inner diameter of the sleeve 20.

The sleeve 20 comprises a deformation bush 20d at its second end 20b, which in this case is in the form of a radial expansion. The sleeve 20 also comprises a tapped portion 20g arranged between the flange 20c and the deformable portion 20e. Between its first and second ends 20a, 20b, and in this order, the sleeve 20 thus comprises the flange 20c, the tapped portion 20g, the deformable portion 20e and the deformation bush 20d.

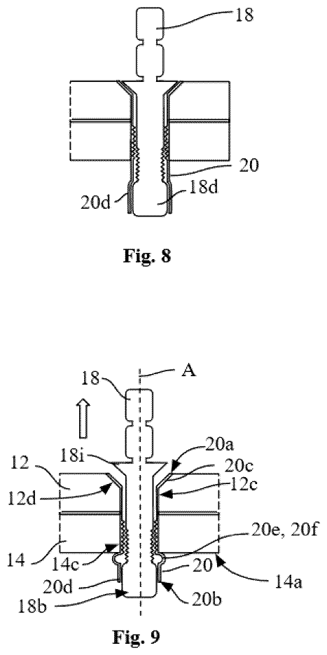

As represented in FIG. 8, since the deformation bush 18d of the actuation rod 18 has a diameter larger than the inner diameter of the sleeve 20, the deformation bush 18d of the actuation rod 18 deforms the sleeve 20 at its deformation bush 20d. The deformation bush 20d of the sleeve 20 is in the form of a protuberance, i.e., a radial expansion. The deformation bush 18d of the actuation rod 18 deforms the sleeve 20 locally, and creates a local radial expansion of the sleeve 20 in relation to the deformation bush 18d of the actuation rod 18.

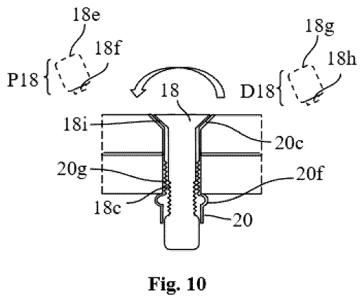

In order to fasten the first and second elements 12, 14 together, and as represented in FIG. 9, the actuation rod 18 is translated in relation to the sleeve 20, with the sleeve 20 being maintained in the orifices 12c, 14c of the elements 12, 14. More specifically, the actuation rod 18 is drawn along the longitudinal axis A in relation to the sleeve 20, in a direction opposite the sleeve 20. The flange 18i of the actuation rod 18 is then no longer supported against the flange 20c of the sleeve, and is spaced from the flange 20c of the sleeve. This traction of the actuation rod 18 has the consequence of driving a portion of the sleeve 20 comprising the second end 20b of the sleeve 20 in the direction of the assembly, along the longitudinal axis A. The second end 20b of the sleeve 20 and the second end 18b of the actuation rod 18 are at a shorter distance from the first face 14a of the second element 14 after deformation of the sleeve 20. With the first end 20a of the sleeve 20 being maintained supported against the widening 12d of the orifice 12c of the first element 12, the traction of the actuation rod 18 has the consequence that a compression force is exerted between the first and second ends 20a, 20b of the sleeve 20, such that the deformable portion 20e of the sleeve 20 is deformed under the force applied by the traction of the actuation rod 18 in relation to the sleeve 20, and forms a deformation bulb 20f which blocks the sleeve 20 supported against the first face 14a of the first element 14. The deformable portion 20e of the sleeve 20 is controlled in its radial expansion by the traction of the actuation rod 18 in relation to the sleeve 20, and more specifically by the traction of the deformation bush 18d of the actuation rod 18 in relation to the deformation bush 20d of the sleeve 20. The traction of the actuation rod 18 has also made it possible to arrange the threaded portion 18c of the actuation rod 18 facing the tapped portion 20g of the sleeve 20. Once the deformation bulb 20f has been formed, and as represented in FIG. 10, the actuation rod 18, and in particular the first drive nut 18e, is rotated by means of a tightening tool (not represented in the figures) manipulated by an operator, in relation to the sleeve 20, until the flange 18i of the actuation rod 18 is supported against the flange 20c of the sleeve 20. During this rotation of the actuation rod 18, the threaded portion 18c of the actuation rod 18 cooperates with the tapped portion 20g of the sleeve 20.

The method for installation of this second type of blind fastening device 10 differs from the method for installation of the first type of blind fastening device in that:
during the step E10 of insertion of the blind fastening device 10 into the orifices 12c, 14c of the first and second elements 12, 14 which are designed to be assembled, the deformation bush 18d of the actuation rod 18 deforms the sleeve 20 at its deformation bush 20d.
the step E20 of deformation of the deformable portion 20e of the sleeve 20 in this case comprises a sub-step of traction of the actuation rod 18 in relation to the sleeve 20, which has the consequence of driving the second end 20b of the sleeve 20 in the direction of its first end 20a. With the sleeve 20 being maintained by its flange 20c against the first face 12a of the first element 12, and the traction of the deformation bush 18d forming a radial protuberance of the actuation rod 18 in the deformation bush 20d forming a radial expansion of the sleeve 20, this makes it possible to give rise to compression of the sleeve 20, and in particular compression of the deformable portion 20e of the sleeve 20 against the first face 14a of the second element 14. With the deformable portion 20e being designed to be deformed further to the application of a compression force greater than a predetermined threshold, when this predetermined threshold is exceeded further to the traction of the actuation rod 18 in relation to the sleeve 20, this gives rise to deformation of the deformable portion 20e, and to the creation of the deformed portion 20f of the sleeve 20.

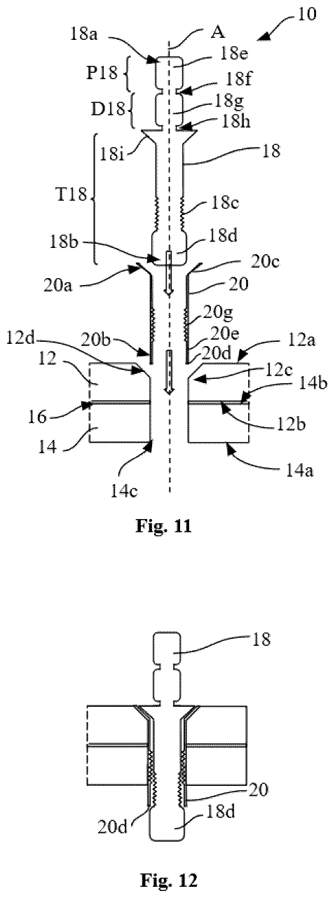

FIGS. 11 to 13 represent the installation of another second type of blind fastening by traction and tightening.

The sleeve 20 comprises a deformation bush 20d at its second end 20b which in this case is in the form of a support surface. The deformable portion 20e of the sleeve 20 is arranged at its second end 20b.

As represented in FIG. 12, after installation of the actuation rod 18 in the sleeve 20, the deformation bush 18d of the actuation rod 18 extends beyond the second end 20b of the sleeve 20. Since the deformation bush 18d of the actuation rod 18 has a diameter larger than the inner diameter of the sleeve 20, and the actuation rod 18 projects in relation to the sleeve 20, the deformation bush 18d of the actuation rod 18 is supported against the deformation bush 20d of the sleeve 20.

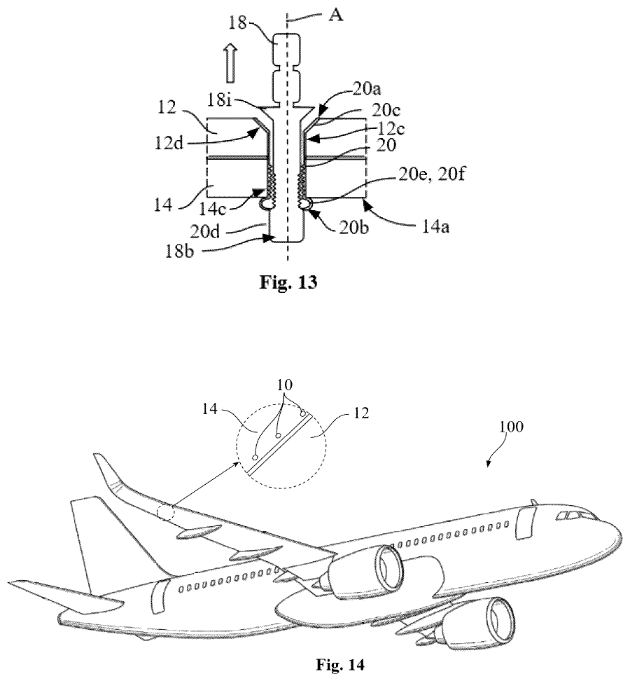

In order to fasten the first and second elements 12, 14 together, and as represented in FIG. 13, the actuation rod 18 is translated in relation to the sleeve 20, with the sleeve 20 being maintained in the orifices 12c, 14c of the elements 12, 14. More specifically, the actuation rod 18 is drawn along the longitudinal axis A in relation to the sleeve 20, in a direction opposite the sleeve 20. This traction of the actuation rod 18 has the consequence of driving a portion of the sleeve 20 comprising the second end 20b of the sleeve 20 in the direction of the assembly, along the longitudinal axis A. With the first end 20a of the sleeve 20 being maintained supported against the widening 12d of the orifice 12c of the first element 12, the traction of the actuation rod 18 has the consequence that a compression force is exerted between the first and second ends 20a, 20b of the sleeve 20, such that the deformable portion 20e of the sleeve 20, situated at the second end 20b of the sleeve 20, is deformed under the force applied by the traction of the actuation rod 18 in relation to the sleeve 20, and forms a deformation bulb 20f which blocks the sleeve 20 supported against the first face 14a of the first element 14. The deformable portion 20e of the sleeve 20 is controlled in its radial expansion by the traction of the actuation rod 18 in relation to the sleeve 20, and more specifically by the traction of the deformation bush 18d of the actuation rod 18 against the deformation bush 20d of the sleeve 20.

The method for installation of this third type of blind fastening device 10 differs from the method for installation of the second type of blind fastening device in that:
during the step E10 of insertion of the blind fastening device 10 in the orifices 12c, 14c of the first and second elements 12, 14 which are designed to be assembled, the deformation bush 18d of the actuation rod 18 is supported against the deformation bush 20d of the sleeve 20.
the step E20 of deformation of the deformable portion 20e of the sleeve 20 in this case comprises a sub-step of traction of the actuation rod 18 in relation to the sleeve 20, which has the consequence of driving the second end 20b of the sleeve 20 in the direction of its first end 20a. With the sleeve 20 being maintained by its flange 20c against the first face 12a of the first element 12, and the traction of the deformation bush 18d forming a radial protuberance of the actuation rod 18 against the deformation bush 20d of the sleeve 20 forming a support surface, this makes it possible to give rise to compression of the sleeve 20, and in particular to compression of the deformable portion 20e of the sleeve 20 against the first face 14a of the second element 14. Since the deformable portion 20e is designed to be deformed further to the application of a compression force greater than a predetermined threshold, when this predetermined threshold is exceeded further to the traction of the actuation rod 18 in relation to the sleeve 20, this gives rise to deformation of the deformable portion 20e, and to the creation of the deformed portion 20f of the sleeve 20.

An aircraft 100 comprising an assembly of a first element 12 and a second element 14 by blind fastening devices 10 according to the invention is represented in FIG. 14. The blind fastening device according to the invention has been described for the fastening of two elements of an aircraft, but it will be appreciated that it can be used to fasten together more than two elements without departing from the context of the invention. In addition, the elements to be assembled can be different types of parts to be assembled of an aircraft, such as, for example, and in a non-limiting manner, structural parts, floor parts, cabin parts, and tank parts of an aircraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A blind fastening device for fastening of an assembly of a first element to a second element, an interface seal being positioned between the first element and the second element, the first element and the second element each comprising an orifice with a first inner diameter, the blind fastening device comprising:
an actuation rod with a first end and a second end, the actuation rod comprising a first drive nut at the first end, a first rupture groove between the first drive nut and the second end, a threaded portion between the first rupture groove and the second end, and a deformation bush at the second end; and,
a sleeve configured to be inserted in the orifices of the first element and the second element and having a first outer diameter which is substantially equal to the first inner diameter, the sleeve configured to be threaded onto the actuation rod, and the sleeve further comprising a first end, a second end, a tapped portion between the first end and the second end, a deformation bush at the second end, and a deformable portion between the first end and the second end and which is configured to be deformed radially until the sleeve has a second outer diameter larger than the first outer diameter, when the deformation bush of the actuation rod cooperates with the deformation bush of the sleeve,
wherein the first rupture groove is configured to rupture when a tightening torque applied to the first drive nut creating a cooperation of the threaded portion of the actuation rod with the tapped portion of the sleeve exceeds a first predetermined torque,
wherein the actuation rod comprises a second drive nut followed by a second rupture groove between the first rupture groove and the threaded portion, the second rupture groove configured to rupture when a re-tightening torque applied to the second drive nut exceeds a second predetermined torque greater than the first predetermined torque.

2. The blind fastening device as claimed in claim 1, wherein the deformation bush of the actuation rod comprises a thread, and
wherein the deformation bush of the sleeve comprises a tapping.

3. The blind fastening device as claimed in claim 1, wherein the deformation bush of the actuation rod comprises a radial protuberance, and
wherein the deformation bush of the sleeve comprises a radial expansion.

4. The blind fastening device as claimed in claim 1, wherein the deformation bush of the actuation rod comprises a radial protuberance, and
wherein the deformation bush of the sleeve comprises a support surface against which the deformation bush of the actuation rod is supported.

5. A method for installation of the blind fastening device of claim 1 to fasten the first element to the second element, the method comprising:
inserting the blind fastening device in the orifices of the first element and the second element;
cooperating the deformation bush of the actuation rod with the deformation bush of the sleeve to deform the deformable portion of the sleeve radially until the sleeve has a second outer diameter larger than the first outer diameter, wherein the cooperating of the deformation bush of the actuation rod with the deformation bush of the sleeve facilitates an arranging of the threaded portion of the actuation rod facing the tapped portion of the sleeve;
screwing the threaded portion of the actuation rod into the tapped portion of the sleeve, via the first drive nut, until the first rupture groove ruptures;
re-tightening the threaded portion of the actuation rod in the tapped portion of the sleeve, via the second drive nut, until the second rupture groove ruptures.

6. The method as claimed in claim 5, wherein the deformation bush of the actuation rod comprises a thread,
wherein the deformation bush of the sleeve comprises a tapping, and
wherein the cooperating includes screwing the deformation bush of the actuation rod into the deformation bush of the sleeve such that the thread of the deformation bush of the actuation rod cooperates with the tapping of the deformation bush of the sleeve.

7. The method as claimed in claim 5, wherein the deformation bush of the actuation rod comprises a radial protuberance,
wherein the deformation bush of the sleeve comprises a radial expansion, and
wherein the cooperating includes gripping the deformation bush of the actuation rod in the deformation bush of the sleeve such that the radial protuberance of the deformation bush of the actuation rod cooperates with the radial expansion of the deformation bush of the sleeve.

8. The method as claimed in claim 5, wherein the deformation bush of the actuation rod comprises a radial protuberance,
wherein the deformation bush of the sleeve comprises a support surface, and
wherein the cooperating includes gripping the deformation bush of the actuation rod in the deformation bush of the sleeve such that the radial protuberance of the deformation bush of the actuation rod cooperates with the support surface of the deformation bush of the sleeve.
